(19) United States
(12) Patent Application Publication
(10) Pub. No.: US 2006/0225330 A1
(43) Pub. Date: Oct. 12, 2006

(54) Visor sign

(75) Inventor: Nanette Dion-Winn, Naples, FL (US)

Correspondence Address: CHRISTOPHER PARADIES, PH.D., FOWLER WHITE BOGGS BANKER, P.A., 501 E KENNEDY BLVD, STE. 1900, TAMPA, FL, 33602, US

(73) Assignee: WINNCO, LLC, Naples, FL (US)

(21) Appl. No.: 11/101,212

(22) Filed: Apr. 7, 2005

(51) Int. Cl. G09F 21/04

(52) U.S. Cl. 40/593

(57) ABSTRACT

A visor sign is disclosed having a sign with a hole and an elastic band secured to the sign through the hole. The elastic band is selected to have a length and elasticity sized for retaining the sign in a secured position on visors of vehicles, unless the driver or an occupant moves the sign to a raised storage position or a lowered display position. The sign may provide a space for writing user information or may be a permit, such as a permit for parking.

### FIELD OF THE INVENTION

The field is automobile signs that are displayed through the front windshield of an automobile.

### BACKGROUND

It is known to hang signs from the rearview mirror mount that display through the front windshield of an automobile. However, signs dangling from the rearview mirror obscure the driver's view of traffic, requiring the sign to be removed and replaced only when needed and not while driving. Often the hanging signs are misplaced when removed from the rearview mirror, causing the driver to hunt through all of the storage compartments in the car to locate the misplaced sign, which may have fallen between the seats or in an area not easily accessible to the driver.

Storage compartments that clip or are strapped to a visor are known that allow a driver or occupant of a vehicle to store items frequently used by the driver or occupant. Such a system would allow the driver to store a hanging sign, but such storage compartments inevitably collect an array of papers and signs and other items that make locating of a particular item, such as a sign, increasingly difficult.

### SUMMARY OF THE INVENTION

A visor sign includes a sign to be displayed through the front windshield of an automobile and an elastic band with a length selected such that the elastic band fits snugly around visors in vehicles. The elastic band passes through a hole formed in one end of the sign. The elastic band may be secured on the visor such that the sign is displayed when the visor is either open or closed.

One advantage of the visor sign is that the sign may be lowered merely by pulling on the sign which slides on the elastic band or allows the elastic band to slide on the visor, deploying the sign such that the sign is visible through the front windshield of the automobile. Another advantage of the visor sign is that the sign may be stored in a position that does not block the view of the driver during driving of the vehicle by merely pushing the sign upwards towards the visor. Again, the sign slides on the elastic band or the elastic band slides around the visor, removing the sign from the field of view of the driver. Furthermore, the sign remains positioned where the driver or occupant of the vehicle pushes the sign, when the elastic band is sufficiently taut to keep the sign from slipping back into the field of view of the driver.

### BRIEF DESCRIPTION OF THE FIGURES:

The drawings and detailed description provide specific examples of the invention, but the invention should not be limited merely to the examples disclosed. Instead, the invention should be limited only by the claims that may eventually issue. Many variations in the system, changes in specific components of the system and uses of the system will be readily apparent to those familiar with the field of the invention based on the drawings and description provided. The examples are not intended to limit the scope of any claims that issue. The scope of the claims should be limited only by the language of the claims themselves.

FIG. 1 shows an embodiment of the present invention.

FIG. 2 shows another embodiment of the present invention; however, only a portion of the elastic band is shown.

FIG. 3 shows one example of an elastic band that has a retainer connecting the ends of an elastic to form a loop.

FIG. 4a shows one cross-section of the band of FIG. 3.

FIG. 4b shows another cross-section of the band of FIG. 3.

FIG. 4c shows a tab for securing a sign to an elastic band having a cross-section of FIG. 4a.

FIG. 4d shows another tab for securing the sign to an elastic band having a cross-section shown in FIG. 4b.

FIG. 5 illustrates yet another embodiment with only a portion of the elastic band shown.

### DETAILED DESCRIPTION

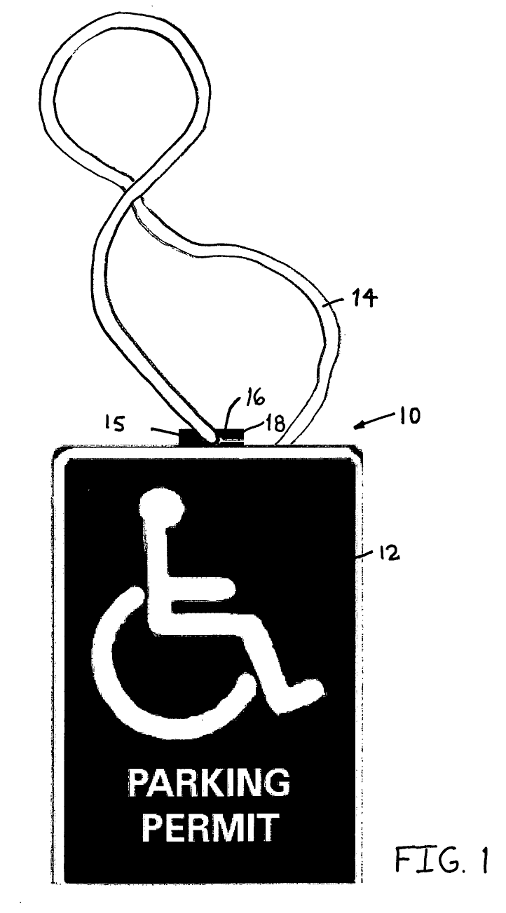

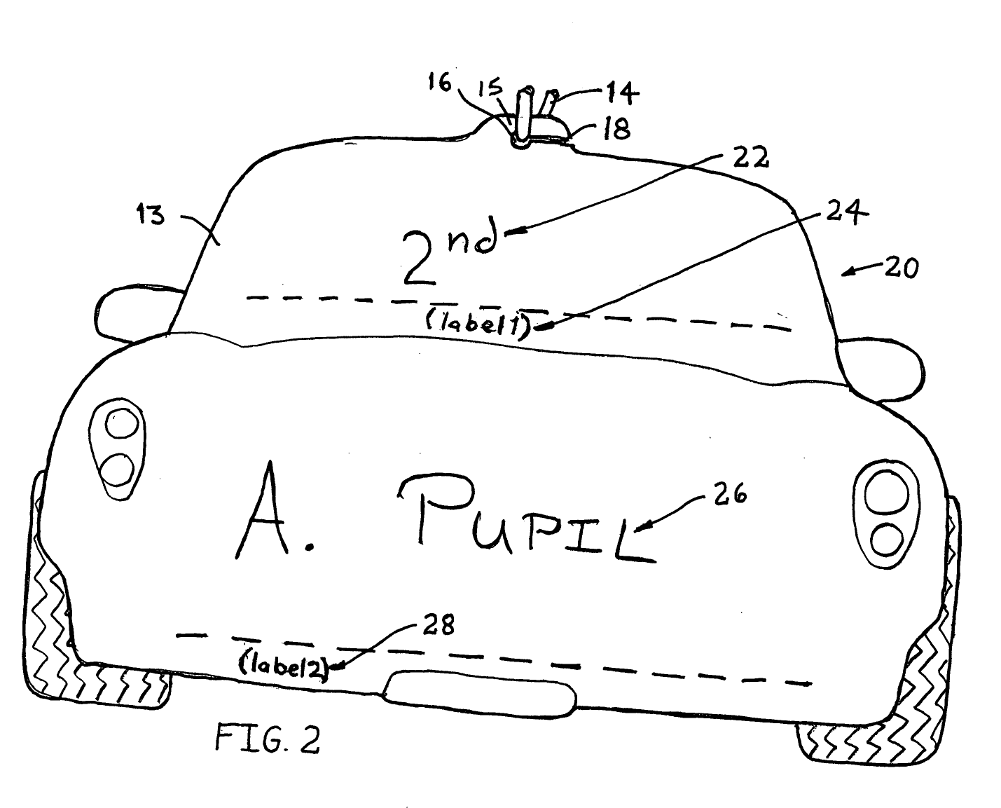

FIG. 1 shows one embodiment of a visor sign 10 having a handicap parking permit 12 and an elastic band 14. The elastic band 14 is secured to the handicap parking permit 12 by tab 15. Tab 15 has a hole 16 and a slot 18 leading from one edge of tab 15 to the hole 16. FIG. 2 illustrates another embodiment of a sign 10 used in picking up a child from school. Only a portion of the elastic band 14 is shown.

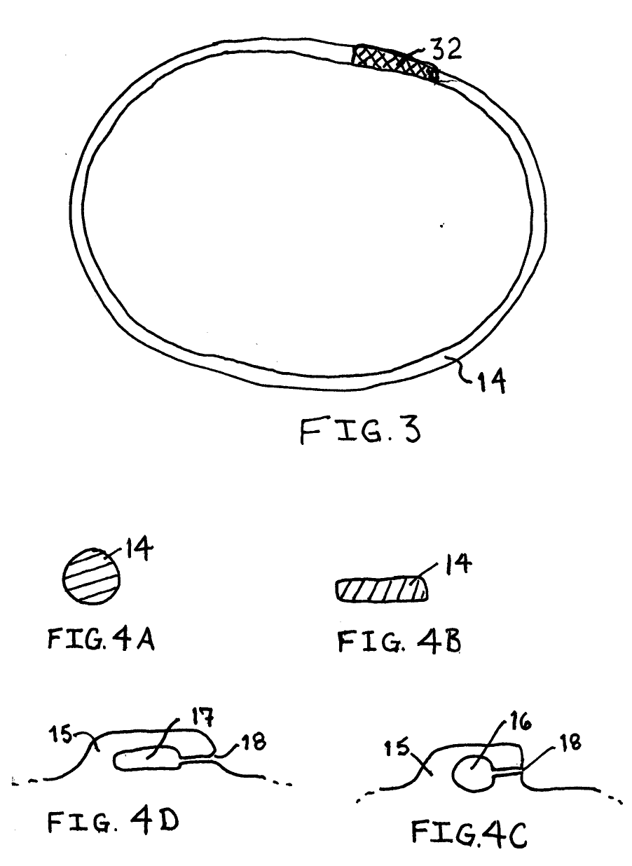

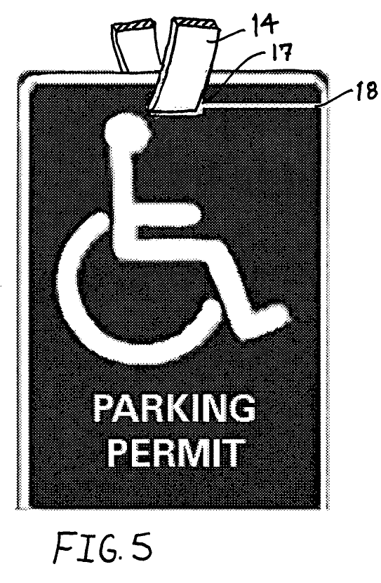

Any known elastic band 14 or other stretchable line, rope or band may be used to secure the visor sign 10, 20 to a visor in an automobile. In FIG. 3 the elastic band 14 is made of elastic connected at its two ends by a retainer 32. In one embodiment the elastic band 14 is made of elastic having a circular cross-section, such as shown in FIG. 4A. In this case, the tab 15 has a circular hole 16 and a slot 18, as shown in FIG. 4C, for example. The slot 18 is shown in FIGS. 4c and 4d as having a finite width; however, the slot may be merely a slit made in the tab 15, which allows a continuous, untied loop of elastic 14 to be inserted through the slot 18 and positioned in the hole 16 of tab 15. A slit is merely a cut in the material of the tab 15 that does not remove any material from the tab 15, leaving no gap between the hole 16 and the edge of the tab 15.

In an alternative embodiment, tab 15 has no slot 18, and the elastic band 14 is inserted through the hole 16 and secured by a retainer 32, a knot, or in any other way known in the art. A retainer 32 may be any device used to secure two ends of elastic into a loop of an elastic band 14, such as shown in FIG. 3. In one example, the retainer is metal and is mechanically crimped to fasten each end of an elastic rope or band into a closed loop. In another example, a flexible retainer is formed from a polymer that binds the two ends of the elastic into a loop. The polymer may be formed of an elastic material or of an epoxy resin, for example.

More preferably, a continuous elastic band 14 is manufactured in the form of an elastic loop 14 without the use of any retainer 32 and is used as shown in FIG. 1. A continuous elastic band is uninterrupted by a retainer in the loop. A continuous band 14 allows the sign 10, 20 to move freely on the elastic band 14, and the elastic band 14 to move freely on the visor, without becoming snagged on any retainer 32. Also, a continuous loop of elastic 14 is believed to be more durable and less likely to break than a band 14 that includes a retainer 32, such as shown in FIG. 3.

If a continuous band 14 is used, then the hole 16, 17 for securing the band 14 to the sign 12, 13 may have a slot 18, which allows the band 14 to be inserted into the hole 16, 17. In this case, it is preferred to have a tab 15, which allows the slot 18 to be disposed in the side of the tab, as shown in FIGS. 4c and 4d. Thus, when the sign is pulled in order to lower the sign or is pushed in order to raise the sign, the elastic band 14 is not pulled free from the hole 16, 17 through the slot 18.

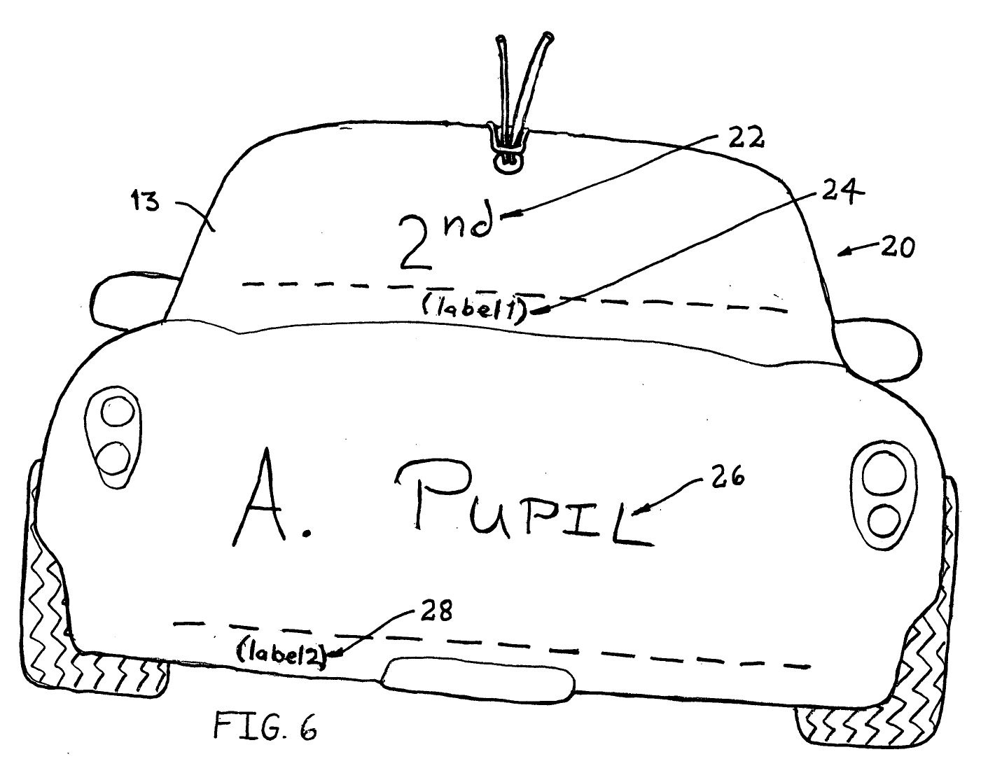

Alternatively, as shown in FIG. 5, a slot 18 may extend across a portion of the width of the sign 50, itself. In either case, the sign 10, 20, 50 and/or the tab 15 may be made of any material with a thickness that makes the sign acceptably rigid, having a stiffness and strength that prevents the elastic band 14 from being removed accidentally from the hole 16 during raising and lowering. In one alternative, the tab 15 is made of a rigid thermoset polymer and is fixedly attached to the sign 10, 20. In this case, the material of the sign may be made of a more flexible material.

In yet another alternative, a continuous elastic band 14 may be inserted into a hole 16 without a slot by passing one portion of the band 14 through the hole 16 and forming a half hitch knot 62, for example such a knot 62 prevents the sign 13 from sliding on the band 14, but the band 14 is capable of sliding on the visor without catching on any knot in the band 14.

The sign 50 or both the sign 12, 13 and the tab 15 may be made of plastic sheet. Any type of plastic may be used but it is preferable to use a type of plastic that may be screen printed or otherwise processed to display an image or to impart a message, such as shown in In one example the plastic used was a polyester. The thickness of the polyester was ______, which provided a rigid sign capable of being raised and lowered while remaining the elastic band 14. Alternatively, a high-density polyethylene, medium-density polyethylene or low-density polyethylene may be used. In yet another example card stock may be used that is either protected by a plastic film or not. In yet another example, polystyrene is used. When polystyrene is used, it is preferred not to use a slot 18 or a tab 15. Instead, as shown in FIG. 6, a hole 4 may be paced in the sign.

In the example of FIG. 2, the sign 20, itself, is formed in the shape of a vehicle. The vehicle could be any vehicle including the shape of a car, truck, sports utility vehicle or any other vehicle. In the example of FIG. 2, space is left for the user of the sign 20 to insert user information 22, 26. For example, the sign 20 may be made of a material that allows the user to enter a name using a marker. The sign 20, itself, may suggest the information to insert based on labels 24, 28 if applicable. The labels 24, 28 may be text, illustrations or both, which indicate the information that should be entered on the sign 20 by the user. In one example, a first label 24 may request a child's grade, and a second label 28 may request a child's name. By inserting the grade 22 and the name 26 on the sign 20, a parent may identify a particular child and grade for pickup at a local school, for example.

By merely pulling on the sign 20, the sign is lowered such that a school official may identify the child to be picked up by the parent. When the child is securely in the vehicle, the parent or another occupant may merely push the sign 20 back up to be held by the elastic band 14 against the visor, where the sign 20 does not obscure the driver's view of the road.

The length of the elastic band 14 is selected such that the elastic band 14 securely retains the sign 10, 20, 50 on the visor of the automobile in both the raised and the lowered positions. For example, it is believed that a circumferential length of between about seven inches to about eleven inches is capable of holding a sign 10, 20, 50 on the visor of nearly all vehicles that have visors. In one example, the circumferential length of a continuous elastic loop 14 was ten inches. This loop 14 securely fastened the signs 10, 20, 50 on the visor of vehicles, without overstretching the elastic material of the loop 14. It is believed, without be limiting, that overstretching the elastic band 14 may cause premature failure of the elastic band 14, either by breakage or by rapid loss of elasticity. Increasing the length of an elastic band 14 having a circular cross-section greater than eleven inches may cause the band 14 to have insufficient tension to securely hold the sign 10, 20, 50 on automobile visors with smaller visor widths and thicknesses.

Band cross-sectional shape may be selected for the elastic band 14, such as shown in FIGS. 4a and 4b, so long as the hole 16, 17 is shaped to accommodate the cross-section of the elastic band 14. FIGS. 4a and 4b illustrate two typical cross-sections for elastic bands in an enlarged cross-sectional view; however the cross-sectional shape is not limited to these examples. Preferably, the size of the holes 16, 17 are selected to be equal to or larger than the cross-sectional size of the elastic band 14, allowing the sign 10, 20 to slide on the band 14.

What is claimed is:

1. A visor sign for display mounting on visors of vehicles, comprising:
a sign having a hole; and
an elastic band secured to the sign through the hole and forming a closed loop;
wherein the length and elasticity of the band is selected such that the sign is held in position on visors of vehicles by the tensional force of the band.

2. The visors of claim 1, wherein the sign moves from a stowed position adjacent to the visor to a lowered position by pulling and returns to the stowed position by pushing, such that the sign is visible through a front windshield of the vehicle when in the lowered position and does not obscure the driver's view when in the stowed position.

3. The visor sign of claim 2, wherein the sign is a parking permit.

4. The visor sign of claim 2, wherein the sign has a shape of a vehicle.

5. The visor sign of claim 4, wherein the sign has at least one label and at least one area for entering user information on the sign.

6. The visor sign of claim 5, wherein the user information is used to identify a child.

7. The visor sign of claim 1, wherein the sign includes a tab, and the hole is at least partially within the tab.

8. The visor sign of claim 7, wherein the tab has two side edges and a top edge, the distance between the two side edges being less than the width of the remainder of the sign, and one of the two side edges has a slot extending from the side edge to the hole.

9. The visor sign of claim 8, wherein the slot is a slit.

10. The visor sign of claim 9, wherein the sign is comprised of a plastic.

11. The visor sign of claim 10, wherein the plastic of the tab is of a different composition than the plastic of the remainder of the sign.

12. The visor sign of claim 10, wherein the plastic is of a polyethylene.

13. The visor sign of claim 12, wherein the elastic band has a length selected in a range from 7 inches to 11 inches.

14. The visor sign of claim 12, wherein the elastic band is a continuous loop uninterrupted by a fastener.

15. The visor sign of claim 1, wherein the visor sign has no slot.

16. The visor sign of claim 15, wherein the elastic band has two ends, and the two ends are fastened together by a retainer.

17. The visor sign of claim 16, wherein the retained is a flexible retainer.

18. A visor sign for mounting on a visor of a vehicle, comprising:
a sign having a tab, extending from a top surface of the sign, the tab having a hole and a slit extending from the hole to a side edge of the tab; and
a continuous elastic loop capable of being secured in the hole, the loop having a circumferential length and elasticity selected such that the sign is retained in a stationary position when the loop is stretched around the visor of a vehicle unless a person pulls the sign to display the sign or pushes the sign to stow the sign adjacent to the visor.

19. The visor sign of claim 18, wherein the sign is made of a polymer.

20. The visor sign of claim 19, wherein the polymer is of a polyethylene.
